(19) United States
(12) Patent Application Publication
(10) Pub. No.: US 2022/0402800 A1
(43) Pub. Date: Dec. 22, 2022

(54) SYSTEMS AND METHODS FOR FORMING A MOLD-BONDED LENS

(71) Applicant: LightPath Technologies, Inc., Orlando, FL (US)

(72) Inventor: Jeremy Ben Huddleston, Oviedo, FL (US)

(21) Appl. No.: 17/686,902

(22) Filed: Mar. 4, 2022

Related U.S. Application Data
(60) Provisional application No. 63/200,430, filed on Mar. 5, 2021.

(51) Int. Cl. C03B 11/14; C03B 11/05

(52) U.S. Cl. CPC C03B 11/14; C03B 11/05

(57) ABSTRACT

Fabricating a shaped optical element for refracting light can include placing a first material having a first glass transition temperature in a mold, and compressing and heating the first material to form a first optical element, the first optical element having a first surface and a second surface opposite the first surface. The method can also include placing a second material in the mold adjacent to the first surface of the first optical element, the second material having a second glass transition temperature that is different than the first glass transition temperature, and compressing and heating the second material to form a second optical element having a third surface and a fourth surface opposite the third surface, wherein the first surface of the first optical element and the third surface of the second optical element are bonded together as a result of compressing and heating the second optical element.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

This application claims the benefit under 35 U.S.C. 119(e) to U.S. Provisional Application No. 63/200,430, entitled “SYSTEMS AND METHODS FOR FORMING A MOLD-BONDED LENS,” filed on Mar. 5, 2021, and the entirety of this provisional application is hereby incorporated by reference herein.

### BACKGROUND OF THE INVENTION

### Field

The present disclosure relates to fabrication of precision optical elements, including, but not limited to, fabricating optical doublets.

### Description of the Related Art

Traditional methods of creating a bonded doublet require that each optical element (or component element) of the doublet be manufactured individually and bonded together with an optical adhesive or other bonding agent (e.g., “cement”). This presents several potential problems. For example, the mating surfaces of each component element must be aligned during the bonding process, and the resulting alignment tolerances. Also, decenter or tilt of each component element may degrade the optical performance of the bonded doublet. The optical prescriptions (e.g., the shapes) of the mating surfaces of each component element will be slightly different from each other due to manufacturing tolerances. This optical prescription mismatch may add to optical performance degradation and may cause difficulty in the bonding process due to uneven spreading of adhesive between the mating optical surfaces. In addition, an optical adhesive used for bonding must be carefully selected and may impact optical performance and/or durability of the doublet. Further, the process of aligning and bonding the optical components that are bonded together with adhesive to form the doublet is time consuming and labor intensive. Accordingly, it would be advantageous to have a method for forming an optical doublet that overcomes these problems.

### SUMMARY

Methods and systems for manufacturing molded lenses from two or more different glass materials, each of the glass materials having a different glass transition temperature Tg are disclosed herein. In various embodiments, the application of the methods disclosed herein may include making lenses that are used for chromatic dispersion correction (e.g., an achromatic doublet), aberration control, or other optical performance enhancements that result from the use of disparate materials in an optical device or optical system.

One innovation includes a method of fabricating a shaped multi-element lens. The method can include placing a first material in a mold, the first material having a first glass transition temperature Tg₁, compressing and heating the first material to form a first optical element, the first optical element having a first surface and a second surface opposite the first surface, placing a second material in the mold adjacent to the first surface of the first optical element, the second material having a second glass transition temperature Tg₂ that is different than the first glass transition temperature Tg₁, and compressing and heating the second material to form a second optical element having a third surface and a fourth surface opposite the third surface, wherein the first surface of the first optical element and the third surface of the second optical element are bonded together as a result of compressing and heating the second material.

Various embodiments of such methods can include more or other features, some of which are listed below. Typically, the second glass transition temperature Tg₂ is a lower temperature than the first glass transition temperature Tg₁. In some embodiments, the first surface of the first optical element is bonded to the third surface of the second optical element by the interaction of the first material and the second material without the use of another material. In various embodiments, the first surface of the first optical element is bonded to the third surface of the second optical element by the interaction of the first material and the second material without the use of an adhesive. In some embodiments, the first surface of the first optical element is bonded to the third surface of the second optical element by the interaction of molecules of the first material and molecules of the second material. In some embodiments, the first surface of the first optical element has a first optical prescription (e.g. shape), and the third surface of the second optical element has a second optical prescription (e.g., shape) corresponding to the first optical prescription. In some embodiments, the method further includes coating the shaped optical element with an anti-reflective coating. In some embodiments, the method further includes coating the shaped multi-element lens with a coating which blocks predetermined wavebands of light. In some embodiments, the method further includes coating the shaped optical element with a coating which provides abrasion resistance.

In the various methods described herein, the second glass transition temperature Tg₂ is lower than the first glass transition temperature Tg₁ by at least 2 degrees. In some embodiments, the second glass transition temperature Tg₂ is lower than the first glass transition temperature Tg₁ by at least 5 degrees. In some embodiments, the second glass transition temperature Tg₂ is lower than the first glass transition temperature Tg₁ by at least 10 degrees. In some embodiments, the second glass transition temperature Tg₂ is lower than the first glass transition temperature Tg₁ by at least 25 degrees. In some embodiments, the second glass transition temperature Tg₂ is lower than the first glass transition temperature Tg₁ by at least 50 degrees. In some embodiments, the second glass transition temperature Tg₂ is lower than the first glass transition temperature Tg₁ by at least 100 degrees. In some embodiments, the second glass transition temperature Tg₂ is lower than the first glass transition temperature Tg₁ by 100 degrees or more.

In some embodiments, the shaped multi-element lens is an achromatic doublet for chromatic dispersion correction. In some embodiments, the shaped multi-element lens is configured for aberration control. In some embodiments, the shaped multi-element lens can be formed by more than two materials. For example, three, four, or five different materials. In some embodiments, each of the materials used to form the shaped multi-element lens can have a different glass transition temperature. In some embodiments, the method further includes placing a third material in the mold adjacent to a fourth surface of the second optical element, the third material having a third glass transition temperature Tg3 that is lower than the first glass transition temperature Tg₁ and the second glass transition temperature Tg₂, and compressing and heating the third material to form a third optical element having a fifth surface and a sixth surface opposite the fifth surface, the fifth surface bonded to the fourth surface of the second optical element, where heating the third material comprises heating the third material to a temperature lower than the second glass transition temperature Tg₂ and greater than the third glass transition temperature Tg₃.

Another innovation includes a method of forming a shaped multi-element lens, the method including forming a first optical element of the lens from a first material using a compression mold, the first material having a first transition temperature Tg₁, and the first optical element having a first optical prescription surface and a second surface, providing a second material adjacent to the first optical prescription surface, the second material having a second transition temperature Tg₂ that is a lower temperature than the first transition temperature Tg₁, and forming a second optical element using the compression mold, the second optical element having a third optical prescription surface bonded to the first optical prescription surface of the first optical element, wherein said forming the second optical element comprises heating the second material to a temperature less than the first transition temperature Tg₁ and greater than the second transition temperature Tg₂. In some embodiments, said forming a second optical element does not change the optical prescription surface of the first optical element.

Another innovation includes a method of forming a shaped multi-element lens, the method comprising providing a first material in a compression mold, the first material having a first transition temperature Tg₁, applying pressure and a first heat to the first material to form a first optical element of the lens, the first optical element having a prescription surface, placing a second material in the compression mold adjacent to the prescription surface of the first optical element, the second material having a second transition temperature Tg₂ that is a lower temperature than the first transition temperature Tg₁, and applying pressure and a second heat to the second material to form a second optical element bonded to the prescription surface of the first optical element, the second heat being greater than the second transition temperature Tg₂ and less than the first transition temperature Tg₁.

Another innovation includes a method for forming a lens, including forming a first optical element of the lens from a first material using a compression mold, the first material having a first transition temperature Tg₁, the first optical element formed to have a first optical prescription surface and a second surface, and forming a second optical element of the lens from a second material having a second transition temperature Tg₂ that is a lower temperature than the first transition temperature Tg₁, wherein forming the second optical element forms a surface of the second optical element that is bonded to the first optical prescription surface. In some embodiments, forming the second optical element includes heating the second material to a temperature less than the first transition temperature Tg₁ and greater than the second transition temperature Tg₂.

Various implementations of methods and apparatus within the scope of the appended claims each have several aspects, no single one of which is solely responsible for the desirable attributes herein. Without limiting the scope of the appended claims, some prominent features are described herein.

### BRIEF DESCRIPTION OF THE DRAWINGS

FIG. 1 illustrates an example of an optical layout of an achromatic doublet, according to some embodiments.

FIG. 2 illustrates a step of an example of a lens compression molding process that can be used to form a lens that comprises two optical component elements (e.g., the lens of FIG. 1), each component element having a different glass transition temperature (Tg), where a preform material of a first component element is placed into a compression mold.

FIG. 3 illustrates another step of the lens compression molding process, where the first component element is molded to form a first portion of an achromatic doublet.

FIG. 4 illustrates another step of the lens compression molding process, where the second material is placed into the compression mold on the first component element, the second material having a transition temperature that is different (e.g., lower) than the transition temperature of the first component element.

FIG. 5 illustrates another step of the lens compression molding process, where the second component element is molded to form a second portion of the achromatic doublet.

FIG. 6 is a diagram that illustrates glass transition temperature (x-axis) versus Abbe number (y-axis) of several multiple glass types.

### DETAILED DESCRIPTION OF CERTAIN INVENTIVE ASPECTS

As indicated above, traditional methods of creating a bonded doublet require that each optical element of the doublet be manufactured individually and bonded together with an optical adhesive or other bonding agent. This presents several potential problems, including mating surfaces of each component element must be aligned and any decenter or tilt misalignment may degrade the optical performance. Yet, optical prescriptions of the mating surfaces of each optical element may vary due to manufacturing tolerances. In addition, using adhesives can be difficult, degrade performance and durability of the final optical element, and be labor intensive.

In various embodiments, the application of the methods disclosed herein for forming a shaped multi-element lens, where the elements are bonded together during a compression molding process, can address these issues. Such methods may include making lenses that are used for chromatic dispersion correction (e.g., an achromatic doublet), aberration control, or other optical performance enhancements that result from the use of disparate materials in an optical device or optical system. In various implementations, for example, a molded doublet lens can be formed from two disparate glass materials (component elements), each with differing glass transition temperatures (Tg), bonded together through the precision glass molding (PGM) process without the use of an adhesive or cement to hold the two component elements together. Furthermore, the optical prescription (e.g., shape) of one surface of the first component element is utilized during the manufacturing process to form (via molding) the optical prescription (e.g., shape) of the adjacent surface of the second component element, thus comprising the two surfaces (one from each component element) of matching prescription that are bonded together. The heating and pressurization of the molding process of the second component element as it forms in contact with the first component element causes the disparate materials to bond together, such that the resulting doublet lens does not come apart during normal use.

This disclosure includes solutions to the above problems in several ways. First, the bonded surface of the second component element is intrinsically aligned to the mating optical surface of the first component element. Second, the optical prescription (e.g., shape) of the second component element is intrinsically matched to the mating optical surface of the first component element. Third, the bonding of the first and second component elements is achieved via the molding process, thus obviating the need for an adhesive or other bonding agent, and potentially improving performance and durability. And finally, the process of alignment and bonding is integrated into the lens manufacturing process, thus eliminating the additional time and labor for post alignment and bonding.

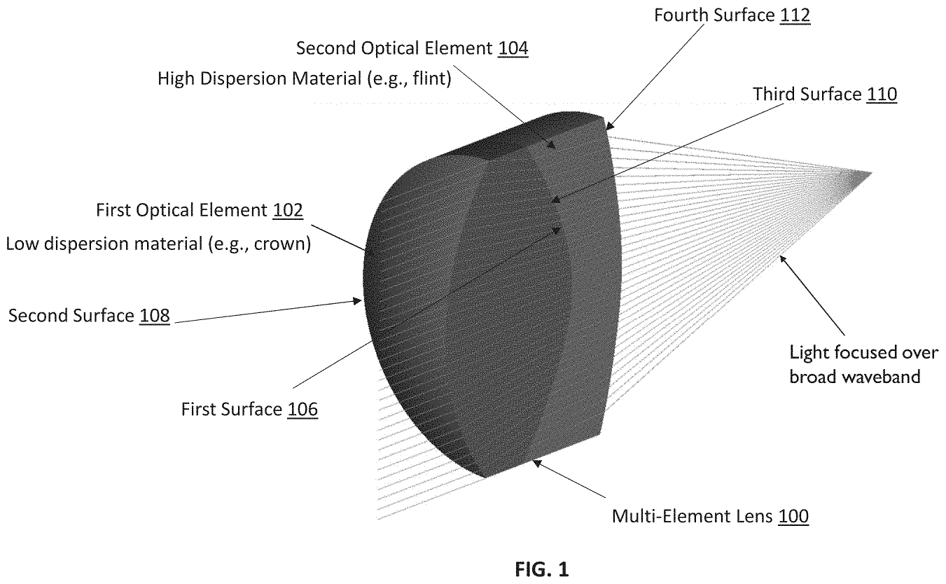

FIG. 1 illustrates an example of an optical layout of a multi-element lens 100 (e.g., an achromatic doublet) that can be fabricated by the methods described herein, according to some embodiments. The lens 100 includes a first optical element 102 having a first surface 106 and a second surface 108. The first optical element 102 is formed from a first material having a first glass transition temperature Tg₁. Lens 100 also includes a second optical element 104 having a third surface 110 and a fourth surface 112. The second optical element 104 is formed from a second material having a second glass transition temperature Tg₂. The second optical element 104 is bonded to the first optical element 102 resulting in the formation of the lens 100 using a compression molding process. Specifically, the third surface 110 of the second optical element 104 is bonded to the first surface 106 of the first optical element 102 without the use of an adhesive. In an example, a method of fabricating the shaped multi-element lens 100 can include placing the first material in a mold, the first material having a first glass transition temperature Tg₁, and then compressing and heating the first material to form the first optical element 102, the first optical element 102 having the first surface 106 and the second surface 108 opposite the first surface 106. The method can further include placing a second material in the mold adjacent to the first surface 106 of the first optical element 102 that has been formed in the compression mold, the second material having a second glass transition temperature Tg₂ that is different (e.g., lower than) than the first glass transition temperature Tg₁. The method can further include compressing and heating the second material to form the second optical element 104 having a third surface 110 and a fourth surface 112 opposite the third surface 110, wherein the first surface 106 of the first optical element 102 and the third surface 110 of the second optical element 104 are bonded together as a result of compressing and heating the second material. The first material and/or the second material can be heated prior to compression, after compression has begun, during at least a portion of the compression or throughout the full duration of the compression. The heating may end prior to compression or after compression.

FIG. 2 illustrates a first step of an example of a lens compression molding process that can be used to form a lens that comprises two optical elements (e.g., the lens of FIG. 1), each optical element having a different glass transition temperature (Tg), where a preform of first material 206 having a first glass transition temperature Tg₁ is placed into a compression mold. In step one, the first material preform 206 is placed between two sections of a compression mold that are configured to compress material there between to form an optical element. In this example, the compression mold is illustrated as having a first top mold 204 and bottom mold 202, and the preform of the first material 206 is placed therebetween.

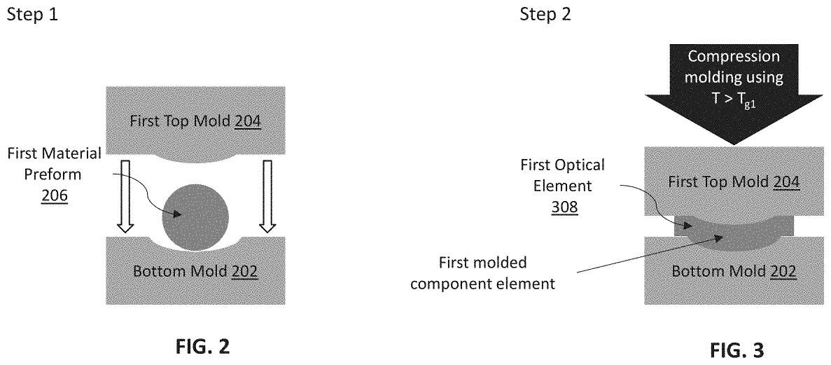

FIG. 3 illustrates a second step of an example of a lens compression molding process where the first material or first material preform or first material 206 is molded to form a first optical element 308 of a doublet. In this step, the first top mold 204 and the bottom mold 202 are moved together and compress the first material preform or first material 206. Heat is applied to the first material preform or first material 206 while it is being compressed or prior to being compressed such that the first material is raised to a temperature that is greater than the glass transition temperature Tg₁ and as a result of the pressure and the heat, the first material preform or first material 206 is shaped into the first optical element 308. The first optical element 308 includes a first surface and a second surface, as illustrated in FIG. 1.

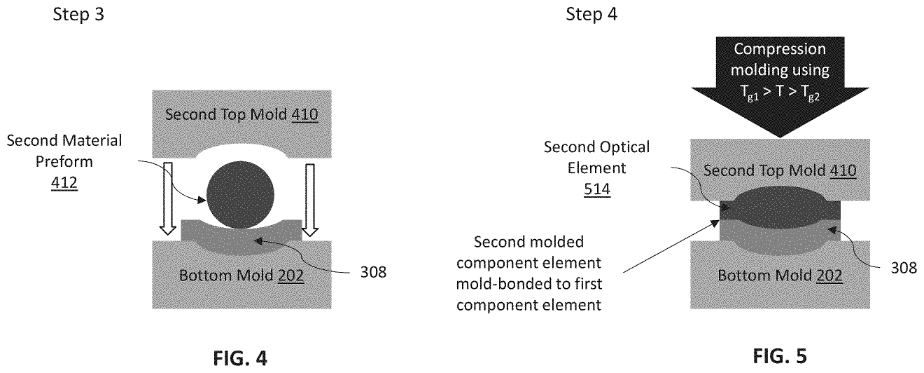

FIG. 4 illustrates another step of the lens compression molding process. In step 3, the compression mold is opened and a preform of a second material 412 is placed into the compression mold adjacent to the first optical element 308. In some embodiments, the preform of the second material 412 is placed in contact with the first optical element 308, for example, in contact with a first surface (e.g., a prescription surface) of the first optical element 308. The second material has a glass transition temperature Tg₂ that is lower than the transition temperature of the first material. Also, a second top mold 410 is used as part of the compression mold, the second top mold 410 having a surface corresponding to the desired prescription surface (e.g., shape) on the outside of the to be formed second optical element.

FIG. 5 illustrates another step of the lens compression molding process. In this step, the second top mold 410 is moved towards the bottom mold 202, compressing the preform of the second material 514 while heat is applied to the second material. That is, heat applied to the second material while it is being compressed such that the second material is raised to a temperature that is greater than the glass transition temperature Tg₂ of the second material but less than the glass transition temperature Tg₁ of the first material. This results in the compression of the second material against the prescription surface of the first optical element 308, and the second material forms a bond with the prescription surface of the first optical element 308 such that the second optical element 514 is bonded to the first optical element 308, thus forming the shaped multi-element lens without the use of an adhesive to bond the first optical element 308 and the second optical element 514 together. In some embodiments, this process can be repeated to a bond third optical element to the second optical element.

In any of the steps describe herein where compression and heating are applied, the timing of the compression and heating may be different or varied. For example, the first material and/or the second material can be heated prior to compression, at the commencement of compression, or may occur after compression has begun, and heating may occur during only a portion of the compression or throughout the full duration of the compression. Thus, heating may commence prior to the start of compression or after the start of compression or simultaneously with the start of compression. Similarly, compression may commence prior to the start of heating or after the start of heating or simultaneously with the start of heating. The heating may end prior to cessation of compression or after compression has ended or simultaneously with cessation of compression. Similarly, compression may end prior to cessation of heating or after heating has ended or simultaneously with cessation of heating.

Also, optical elements made according to the process described herein may have optical power and may have one or more curved surfaces such as shown in the drawings (e.g., FIGS. 1-5). For example, the multi-element lens 100 of FIG. 1 having optical power and curved surfaces could be made according to the process described in FIGS. 2 through 5, and the first optical element 102 and second optical element 104 may comprise first and second lens elements and may have optical power. Similarly, the first optical element 102 and/or second optical element 104 may have one or more curved surfaces. The resulting multi-element lens 100 may as a result also have optical power and one or more curved surfaces. As just one example, as shown in FIG. 1, such a multi-element lens may be used to focus light over a broad waveband.

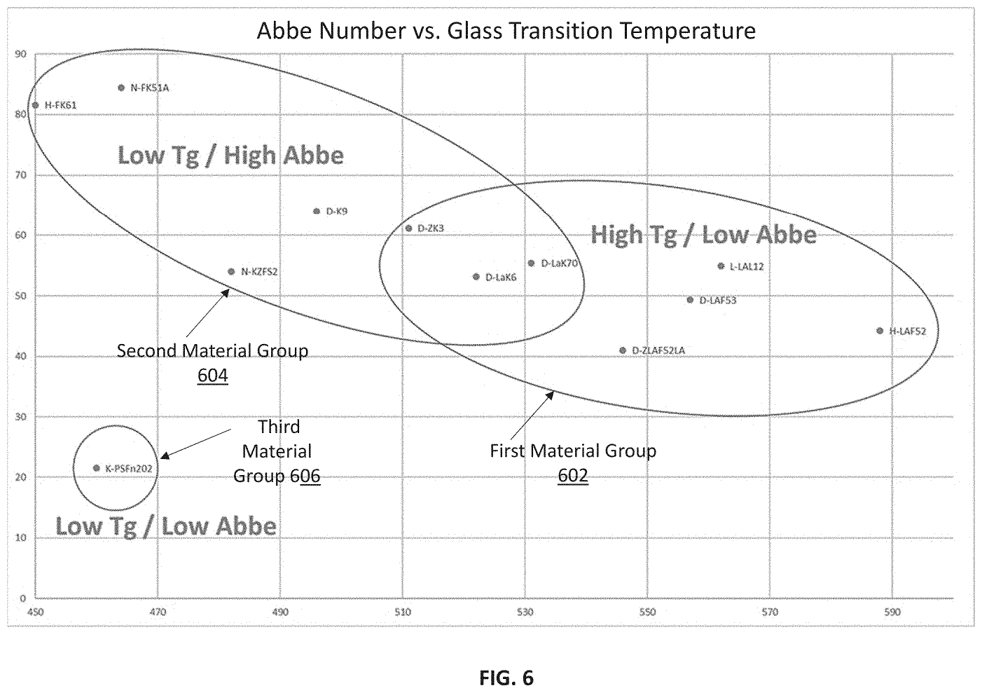

FIG. 6 is a diagram that illustrates glass transition temperature (x-axis) versus Abbe number (y-axis) of several glass types. The glass transition temperature T_{g} of the material characterizes the range of temperatures over which the material conditions change from a hard relatively brittle state into a viscous or rubbery state as the temperature is increased. The glass transition temperature T_{g} is lower than the melting temperature Tₘ of the crystalline state of the material, if such a state exists. The Abbe number is an approximate measure of the material's dispersion of radiation propagating through material. That is, the Abbe number represents the change of refractive index versus wavelength, with higher values indicating lower dispersion. Abbe numbers can be used to classify glass and other optical materials in terms of their chromaticity. For the process described in reference to FIGS. 2-5, in some embodiments a preform of the first material is selected from a first material group 602 which is characterized by having a relatively high glass transition temperature T_{g} and a high dispersion (low Abbe number). In some examples, the first material group 602 can include, but is not limited to, glass types H-FK61, N-FK51A, N-KZFS2, D-K9, D-ZK3, D-LaK6, and/or D-LaK70. In some embodiments, the preform of the second material is selected from a second material group 604 which is characterized by having a relatively low glass transition temperature T_{g} and a low dispersion (high Abbe number). In some examples, the second material group 604 can include, but is not limited to, glass types D-ZK3, D-LaK6, D-LaK70, D-ZLAF52LA, D-LAF3, L-LAL12, and/or H-LAFS2. In some embodiments, the second material can include a glass type from a group 606 which has a low glass transition temperature T_{g} and a low Abbe number, for example, glass type K-PSFn202. The materials which are used to form the first and the second optical elements can be selected to have a certain difference between their glass transition temperatures, which may depend on the molding condition. In some embodiments, the exact ranges can depend on the dilatometry curves of each material, to ensure that the first (high Tg) material would not soften and change its form under the molding conditions of the second (low Tg) material. In some instances, a 50° C. difference in glass transition temperatures is an acceptable difference. In other examples, a 100° C. difference in glass transition temperatures is an acceptable difference. The information in FIG. 6 can be used to determine materials that have an acceptable difference in glass transition temperatures. The glass transition temperature of the first material used to form the first optical element can be referred to as the first glass transition temperature Tg₁. The glass transition temperature of the second material used to form the second optical element can be referred to as the second glass transition temperature Tg₂. In the various methods described herein, the second glass transition temperature Tg₂ is lower than the first glass transition temperature Tg₁ by at least 2 degrees. In some embodiments, the second glass transition temperature Tg₂ is lower than the first glass transition temperature Tg₁ by at least 5 degrees. In some embodiments, the second glass transition temperature Tg₂ is lower than the first glass transition temperature Tg₁ by at least 10 degrees. In some embodiments, the second glass transition temperature Tg₂ is lower than the first glass transition temperature Tg₁ by at least 25 degrees. In some embodiments, the second glass transition temperature Tg₂ is lower than the first glass transition temperature Tg₁ by at least 50 degrees. In some embodiments, the second glass transition temperature Tg₂ is lower than the first glass transition temperature Tg₁ by at least 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 degrees or at least 125 degrees or at least 150 degrees or at least 175 degrees or at least 200 degrees, or any range between these values. In some embodiments, the second glass transition temperature Tg₂ is lower than the first glass transition temperature Tg₁ by more than 100 degrees. Optimal temperature/pressure profiles are dependent on the compression molding and the materials used. In various embodiments, standard parameters that are typically used for pressing each material independently could be used.

### OTHER CONSIDERATIONS

In the foregoing specification, the methods and systems have been described with reference to specific embodiments thereof. It will, however, be evident that various modifications and changes may be made thereto without departing from the broader spirit and scope of the disclosure. The specification and drawings are, accordingly, to be regarded in an illustrative rather than restrictive sense.

Indeed, it will be appreciated that the systems and methods of the disclosure each have several innovative aspects, no single one of which is solely responsible or required for the desirable attributes disclosed herein. The various features and processes described above may be used independently of one another, or may be combined in various ways. All possible combinations and subcombinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination. No single feature or group of features is necessary or indispensable to each and every embodiment.

Additionally, the various processes, blocks, states, steps, or functionalities may be combined, rearranged, added to, deleted from, modified, or otherwise changed from the illustrative examples provided herein. The methods and processes described herein are also not limited to any particular sequence, and the blocks, steps, or states relating thereto may be performed in other sequences that are appropriate, for example, in serial, in parallel, or in some other manner. Tasks or events may be added to or removed from the disclosed example embodiments. Moreover, the separation of various system components in the embodiments described herein is for illustrative purposes and should not be understood as requiring such separation in all embodiments.

It will be appreciated that conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other embodiments. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. Additionally, other embodiments are within the scope of the following claims. In some cases, the actions recited in the claims may be performed in a different order and still achieve desirable results.

Accordingly, the claims are not intended to be limited to the embodiments shown herein, but are to be accorded the widest scope consistent with this disclosure, the principles and the novel features disclosed herein.

What is claimed is:

1. A method of fabricating a shaped multi-element lens, the method comprising:
placing a first material in a mold, the first material having a first glass transition temperature Tg₁;
compressing and heating the first material to form a first optical element, the first optical element having a first surface and a second surface opposite the first surface;
placing a second material in the mold adjacent to the first surface of the first optical element, the second material having a second glass transition temperature Tg₂ that is different than the first glass transition temperature Tg₁; and
compressing and heating the second material to form a second optical element having a third surface and a fourth surface opposite the third surface, wherein the first surface of the first optical element and the third surface of the second optical element are bonded together as a result of compressing and heating the second material.

2. The method of claim 1, wherein the second glass transition temperature Tg₂ is a lower temperature than the first glass transition temperature Tg₁.

3. The method of claim 1, wherein the first surface of the first optical element is bonded to the third surface of the second optical element by the interaction of the first material and the second material without the use of another material.

4. The method of claim 3, wherein the first surface of the first optical element is bonded to the third surface of the second optical element by the interaction of the first material and the second material without the use of an adhesive.

5. The method of claim 3, wherein the first surface of the first optical element is bonded to the third surface of the second optical element by the interaction of molecules of the first material and molecules the second material.

6. The method of claim 1, wherein the first surface of the first optical element has a first optical prescription, and the third surface of the second optical element has a second optical prescription corresponding to the first optical prescription.

7. The method of claim 1, wherein the second glass transition temperature Tg₂ is lower than the first glass transition temperature Tg₁ by at least 25 degrees.

8. The method of claim 1, wherein the second glass transition temperature Tg₂ is lower than the first glass transition temperature Tg₁ by at least 50 degrees.

9. The method of claim 1, wherein the second glass transition temperature Tg₂ is lower than the first glass transition temperature Tg₁ by at least 75 degrees.

10. The method of claim 1, wherein the second glass transition temperature Tg₂ is lower than the first glass transition temperature Tg₁ by at least 100 degrees.

11. The method of claim 1, wherein the second glass transition temperature Tg₂ is lower than the first glass transition temperature Tg₁ by at least 125 degrees.

12. The method of claim 1, wherein the second glass transition temperature Tg₂ is lower than the first glass transition temperature Tg₁ by at least 150 degrees.

13. The method of claim 1, wherein the second glass transition temperature Tg₂ is lower than the first glass transition temperature Tg₁ by at least 175 degrees.

14. The method of claim 1, wherein the second glass transition temperature Tg₂ is lower than the first glass transition temperature Tg₁ by at least 200 degrees.

15. The method of claim 1, wherein the shaped multi-element lens is an achromatic doublet for chromatic dispersion correction.

16. The method of claim 1, wherein the shaped multi-element lens is configured for aberration control.

17. The method of claim 1, further comprising:
placing a third material in the mold adjacent to a fourth surface of the second optical element, the third material having a third glass transition temperature Tg₃ that is lower than the first glass transition temperature Tg₁ and the second glass transition temperature Tg₂.
compressing and heating the third material to form a third optical element having a fifth surface and a sixth surface opposite the fifth surface, the fifth surface bonded to the fourth surface of the second optical element, wherein heating the third material comprises heating the third material to a temperature lower than the second glass transition temperature Tg₂ and greater than the third glass transition temperature Tg₃.

18. A method of forming a shaped multi-element lens, the method comprising:
forming a first optical element of the lens from a first material using a compression mold, the first material having a first transition temperature Tg₁, and the first optical element having a first optical prescription surface and a second surface;
providing a second material adjacent to the first optical prescription surface, the second material having a second transition temperature Tg₂ that is a lower temperature than the first transition temperature Tg₁; and
forming a second optical element using the compression mold, the second optical element having a third optical prescription surface bonded to the first optical prescription surface of the first optical element, wherein said forming the second optical element comprises heating the second material to a temperature less than the first transition temperature Tg₁ and greater than the second transition temperature Tg₂.

19. The method of claim 18, wherein said forming a second optical element does not change the optical prescription surface of the first optical element.

20. A method of forming a shaped multi-element lens, the method comprising:
providing a first material in a compression mold, the first material having a first transition temperature Tg₁;
applying pressure and a first heat to the first material to form a first optical element of the lens, the first optical element having a prescription surface;
placing a second material in the compression mold adjacent to the prescription surface of the first optical element, the second material having a second transition temperature Tg₂ that is a lower temperature than the first transition temperature Tg₁;
applying pressure and a second heat to the second material to form a second optical element bonded to the prescription surface of the first optical element, the second heat being greater than the second transition temperature Tg₂ and less than the first transition temperature Tg₁.

21. A method for forming a lens, comprising:
forming a first optical element of the lens from a first material using a compression mold, the first material having a first transition temperature Tg₁, the first optical element formed to have a first optical prescription surface and a second surface; and
forming a second optical element of the lens from a second material having a second transition temperature Tg₂ that is a lower temperature than the first transition temperature Tg₁, wherein forming the second optical element forms a surface of the second optical element that is bonded to the first optical prescription surface.

22. The method of claim 21, wherein forming the second optical element comprises heating the second material to a temperature less than the first transition temperature Tg₁ and greater than the second transition temperature Tg₂.
